(19) United States
(12) Patent Application Publication
(10) Pub. No.: US 2025/0384033 A1
(43) Pub. Date: Dec. 18, 2025

(54) METADATA QUERY MECHANISM

(71) Applicant: Box, Inc., Redwood City, CA (US)

(72) Inventors: Chandra Cherukuri, San Mateo, CA (US); Miles Spielberg, Sunnyvale, CA (US); Arunabh Shrivastava, Redwood City, CA (US); Amogh Rao, San Jose, CA (US)

(73) Assignee: Box, Inc., Redwood City, CA (US)

(21) Appl. No.: 18/746,466

(22) Filed: Jun. 18, 2024

(51) Int. Cl. G06F 16/2452; G06F 16/21

(52) U.S. Cl. CPC G06F 16/2452; G06F 16/213

(57) ABSTRACT

Disclosed is an improved approach to implement metadata queries, e.g., for content stored in a cloud-based content management system. Instead of being required to create and maintain a separate schema for each document type stored within the system, a single meta schema can be employed to facilitate processing for the metadata query. The meta schema is used to generate a query schema for processing of a query against metadata.

### BACKGROUND

Cloud-based content management services and systems have impacted the way personal and enterprise computer-readable content objects (e.g., files, documents, spreadsheets, images, programming code files, etc.) are stored, and has also impacted the way such personal and enterprise content objects are shared and managed. Content management systems provide the ability to securely share large volumes of content objects among trusted users (e.g., collaborators) on a variety of user devices such as mobile phones, tablets, laptop computers, desktop computers, and/or other devices. Modern content management systems host many thousands or, in some cases, millions of content objects.

It is desirable to provide a mechanism to allow users to search and query within the content stored in a cloud-based content management system. This is beneficial to users, since users often need to search for content objects that include the specific content sought by a user. For example, a user in a sales department may wish to query for all contract documents stored by that department in the cloud storage system having a date range from 2023-2024 which include a sales price greater than $10,000. As another example, a user in the legal department of a company may wish to query for all non-disclosure agreements signed in 2021 which pertain to an employee located in the state of California.

One approach that can been taken to implement these types of search mechanisms is to “flatten” the entirety of the content objects that are loaded into the cloud, so that organizational or hierarchal structure for the document content is removed and the terms or words within the documents become individually searchable at the same “root” level of the search semantics. However, the problem with this approach is that the flattening of the document also removes the ability to search based upon those hierarchical aspects of the data. For example, consider if a document includes a field such as “date” with a value for that field as “2023”. Flattening the document will remove the concept of such fields. While searching may still occur for the specific value “2023” in the flattened document, the flattened document will no longer be able to support a query that searches using the date field.

Another approach that can be taken is to create a specific schema for each type of content, and then load the document contents into a structure that aligns with the schema. For example, for contract documents, a database table schema may be created that includes a column for “date”, where the date field for each document is loaded into that column for the table row associated with that document. This approach would allow a query (e.g., a database query in the SQL language) to query for specific contents using the document fields that are represented in the schema for the table (e.g., where the query includes a predicate for the date field corresponding to the date column in the table). The problem with this approach is that in cloud-based systems, there may be multi-tenancy systems where there are large numbers of tenants that each have a large number of different document types or forms. In this situation, there is no possible way for known systems to support that many different types of schemas, e.g., where a cloud system may have 1,000,000 customers/tenants that each have 1,000 document types, this approach would require 1,000,000×1,000 different schemas, which is beyond the capability of known systems. It is for this reason that a cloud provider may choose to flatten the documents for searching rather than maintain a separate schema for each document type.

Therefore, there is a need for an improved to implement queries in a cloud-based environment that addresses the problems identified above.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

Embodiments of the invention provide an improved approach to implement metadata queries, e.g., for content stored in a cloud-based content management system. With embodiments of the invention, instead of being required to create and maintain a separate schema for each document type stored within the system, a single meta schema can be employed to facilitate processing for the metadata query. The meta schema is used to generate a query schema for processing of a query against metadata.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1 provides an illustration of a content management system.

FIG. 2A provides an illustration of a non-optimal approach to query based upon metadata templates.

FIG. 2B provides an improved solution that overcomes the scaling problem inherent in the approach of FIG. 2A.

FIG. 3 shows a high-level figure of a flowchart to implement some embodiments of the invention.

FIG. 4 shows a detailed flowchart to implement some embodiments of the invention.

FIG. 5A shows an example metadata template.

FIG. 5B shows an example user interface for creating/viewing an object created according to a metadata template.

FIG. 5C shows an example metadata instance that may be created for the document shown in FIG. 5B.

FIG. 5D shows a metadata template used in conjunction with the metadata instance to correspond to an associated query data row in the query store.

FIGS. 5E-1, 5E-2, and 5E-3 show an example of a meta schema.

FIG. 5F shows an example of a query data row that is produced by the combination of the metadata instance and the meta schema.

FIGS. 6, 7, and 8 provide an illustration of the process to process a metadata query according to some embodiments of the invention.

FIG. 9A and FIG. 9B present block diagrams of computer system architectures having components suitable for implementing embodiments of the present disclosure and/or for use in the herein-described environments.

### DETAILED DESCRIPTION

Disclosed herein are techniques for implementing an improved query mechanism to query metadata for content stored in a cloud-based content management system. With embodiments of the invention, instead of being required to create and maintain a separate schema for each document type stored within the system, a single meta (or “master”) schema can be employed to facilitate processing for the metadata query. The meta schema is used to generate a query schema for processing of a query against metadata.

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

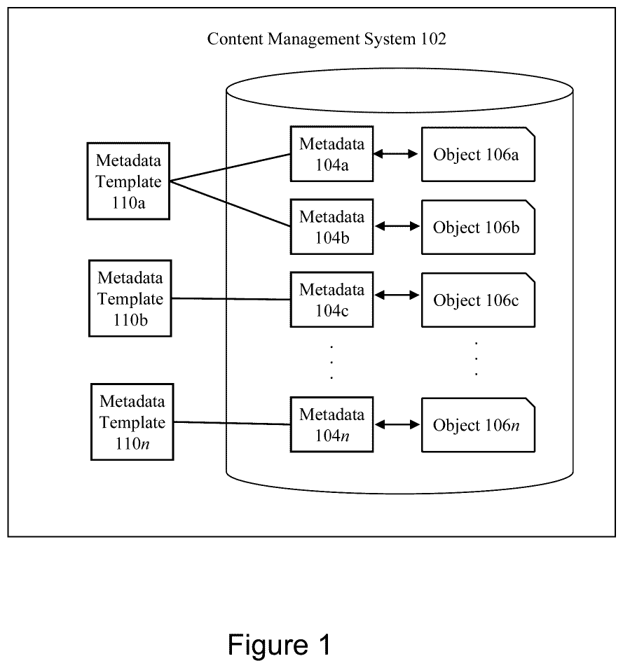

By way of background, FIG. 1 provides an illustration of a content management system 102. Content management system 102 may include numerous content objects 106a-n, where each object corresponds to an item of content that is stored within the system. These content objects may, for example, corresponds to a file in a file system or to an object in an object-based system. For purposed of explanation, any type of content stored within a content management system may be collectively referred to as either an “object” or “file” or “folder” throughout this document, without limitation to any specific characteristic of either a file or an object or a folder.

Each content object may be associated with a set of metadata, such as metadata 104a-n. Metadata defines and stores custom information associated with the files/objects in the system. The metadata values can be set either within a content management application or programmatically via an API (application programming interface).

One way to implement and/or use metadata is through the concept of metadata templates 110a-110n. A metadata template is a logical grouping of metadata attributes that help classify content. For example, a marketing team at a retail organization may have a Brand Asset template that defines a piece of content in more detail. This Brand Asset template may have attributes like “Line”, “Category”, “Height (px)”, “Width (px)”, or “Marketing Approved”.

Metadata templates are useful for numerous reasons. One use case is to enforce uniformity across an enterprise's metadata. Another advantage of such templates is to reduce errors and accelerate data entry by employees or team members. With respect to embodiments of the current invention, the metadata template provides advantages to permit advanced searches with content associated with the metadata template.

As shown in FIG. 1, a metadata template 110a may be defined for a particular use scenario, e.g., for a specific document used by a certain team within an organization. For each instance of an object 106a or 106b that corresponds to this template 110a, each such object will have a set of metadata that is populated for that object according to the metadata template, e.g., where metadata 104a is populated according to template 110a for object 106a. In this way, most or all the objects stored within the content management system 102 will be associated with metadata that corresponds to those stored objects.

As an illustrative use case, consider an application for managing and processing electronic signatures. Metadata templates can be used to automatically add the same fields and formatting to requests for signature. The advantage is that with such templates, the user does not need to repetitively add the same fields to each request every time a new document is sent for signature. Template fields may be provided to allow selection of specific fields for a given template. For example, the following are possible fields to use for an e-signature application: (a) Signature Stamp; (b) Initials; (c) Date signed; (d) Name; (e) Company' (f) Email; (g) Title; (h) Text input; (i) Checkbox field; (j) Attachment; (k) Radio button' (l) Dropdown menu.

Metadata searching can be performed based upon the metadata templates. In particular, to optimize metadata searching, one can implement a metadata query that searches for objects based on metadata templates and attributes.

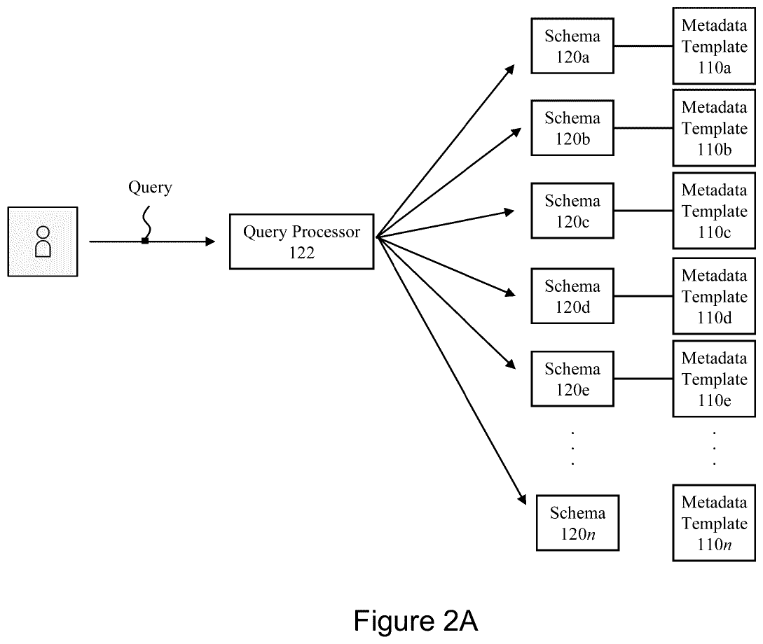

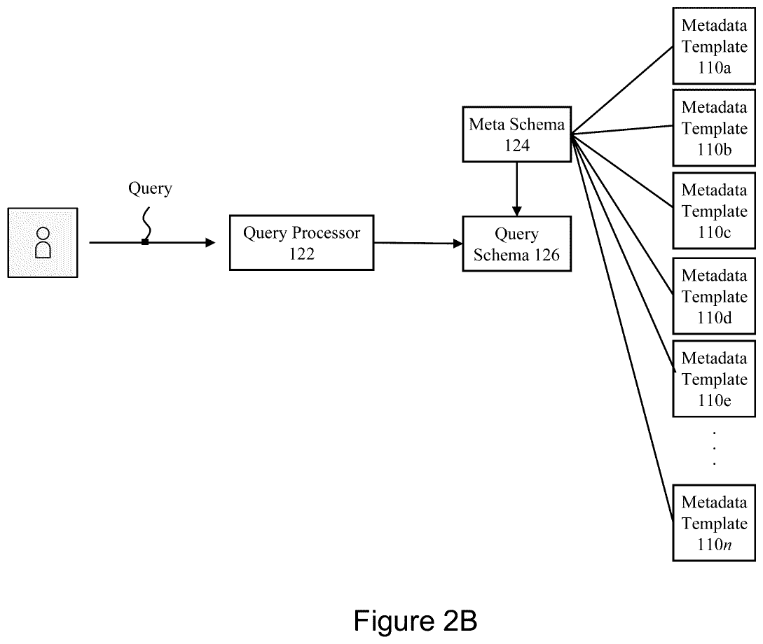

FIG. 2A provides an illustration of a non-optimal approach to query using metadata templates. In this approach, a user may issue a query to a query processor 122 to search for content that matches the criteria set forth in the query. In the approach shown in this figure, a separate schema is created for each type of metadata temple in the system. Here, a schema 120a is created for metadata template 110a, schema 120b is created for metadata template 110b, . . . , and schema 120n is created for metadata template 110n. However, as noted above, the problem with this approach is that in a multitenancy system, there are potentially large numbers of tenants that each have a large number of metadata templates. What this means is that this approach may therefore require the system to maintain an extremely large number of schemas. However, conventional systems just do not have the capacity to handle such a large number of schemas. In effect, the solution illustrated in FIG. 2A is just unable to scale to the requirements of large modern systems.

FIG. 2B provides an improved solution that overcomes the scaling problem inherent in the approach of FIG. 2A. Here, a meta schema is employed that is associated with multiple metadata templates, rather than requiring each template to be associated with its own dedicated schema. When a query is received by the query processor 122, the meta schema is used to dynamically create a query schema that is specific to the one or more metadata templates being queried. However, instead of persistently maintaining such specific schemas, the query schema 126 can instead be created in real time on an as-needed basis.

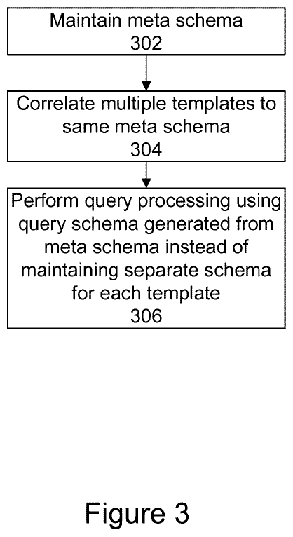

FIG. 3 shows a high-level figure of a flowchart to implement some embodiments of the invention. At 302, a meta schema is maintained for the system. The meta schema includes a comprehensive set of fields that is expansive enough to encompass the individual fields that would otherwise exist within any specific schema for a template.

At 304, multiple metadata templates created in the system are correlated to the same meta schema. What this means is that instead of creating a separate schema for each template, the same meta schema is used for those multiple various templates.

During query processing, at 306, a query schema is generated from the meta schema. The query schema essentially forms a parent tree of fields that encompasses the fields in the template being queries. This creates a format for allowing a structured metadata query to query against the individual metadata fields that are present in the template being queries.

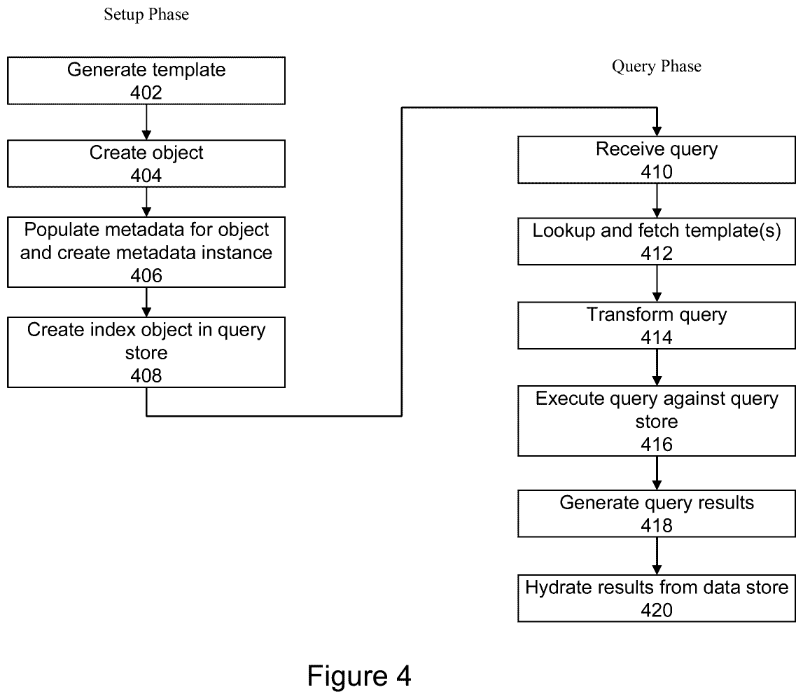

FIG. 4 shows a detailed flowchart to implement some embodiments of the invention. At step 402, one or more metadata templates are generated within the system. Each of the metadata templates generated at this step correspond to a specific object, file, or document to be created for a given purpose, and will therefore be defined to include certain items of metadata to further the purpose of any corresponding objects to be created.

At 404, one or more objects are created that correspond to a metadata template. This action creates an instance of the metadata template. For example, consider if a metadata template is generated for a sales contract for a company at 402. The metadata template will be defined to include filed for information that would be pertinent to a sales contract, such as a date field, customer name field, and price field. During the course of operating the business that is associated with this metadata template, the business may perform sales operations that result in the creation of a sales contract for each customer that makes a purchase. An instance of an object (sales contract) corresponding to the related metadata template would be created for each sales contract, where multiple sales contracts would therefore result in multiple instances of the sales contract objects being created in the system.

At 406, the objects would be populated with metadata as defined by the metadata template for the objects. For example, if the metadata template defines date, customer name, and price as fields for the object, then each of these items of metadata can be populated for the object.

At 408, an index object would be created in a query store for the object. This action extracts relevant metadata from objects created in the system, and stores them into a queryable storage location. Any suitable approach can be taken to extract and store this metadata information. The system essentially analyzes the set of metadata defined by the metadata template, and search for items within a document that match the metadata defined in the metadata template. For example, if the metadata template defines “sales price” metadata, then the system will search the document to try and find a sales price (e.g., using a text/word search or using machine learning), and will then store that identified value as the sales price metadata for the index entry for that object.

At 410, a metadata query may be received from a user to perform a search of the objects. The metadata query may be implemented using a metadata API that allows the user to programmatically find content on the basis of extracted metadata from the underlying objects. With this approach, the query can use a set of parameters and conditions in a structure similar to a traditional SQL query, and identify matching files and folders along with the corresponding metadata.

At 412, the metadata query is processed to lookup and fetch the one or more metadata templates that correspond to the query. In one embodiment, the query itself will refer to the appropriate metadata template that is being queried. Alternatively, the system can infer the appropriate template(s) that should be fetched to process the query, e.g., based upon analysis of the specific user making the query, the permissions held by the user to access documents corresponding to certain template types in the system, and the parameters/fields set forth in the query.

At 414, the query is transformed into a form that is appropriate for execution against the query store. As discussed in more detail below, both the template and the meta schema are used to create one or more intermediate representations of the query before it is executed against the query store at 416. It is this sequence of actions that correlates to the idea of generating a “query schema”, since the transformation(s) into the various different representations will create a search structure that is appropriate for the specific set of metadata being queried.

At 418, query results would then be generated from execution of the query. In some embodiments, execution of the query would generate results from the query store itself, which produces a list of files that match the metadata query results. The underlying files are actually held in a separate content store. Therefore, at 420, the query results would be hydrated from the content store to produce the files (or appropriate file portions) that are match the metadata query results, and which would be provided to the user in response to the query.

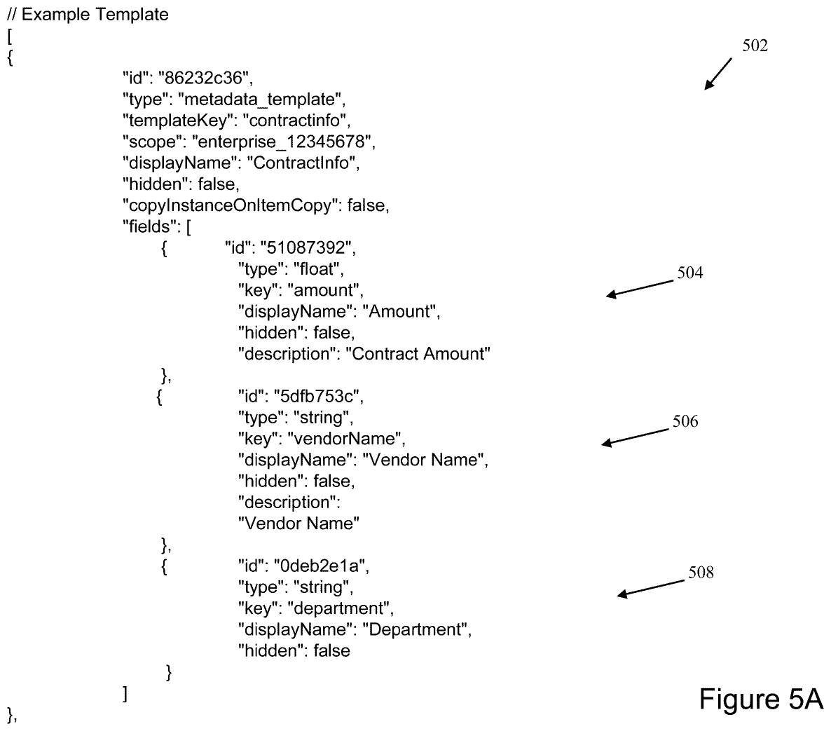

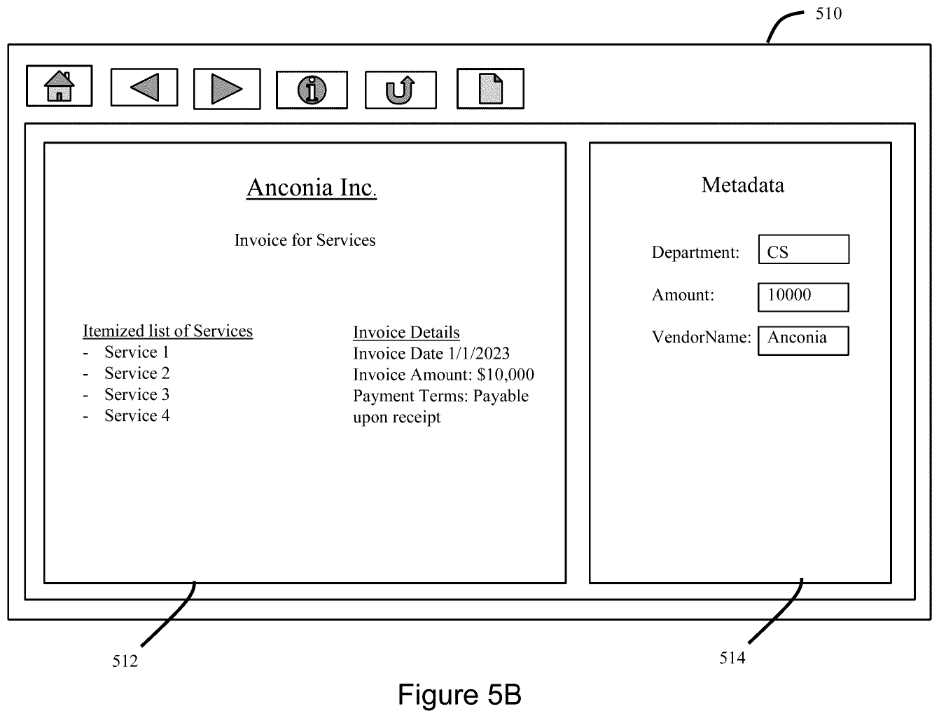

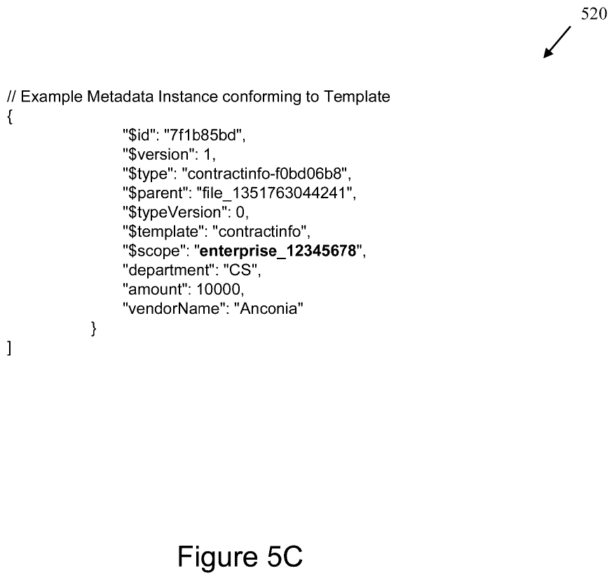

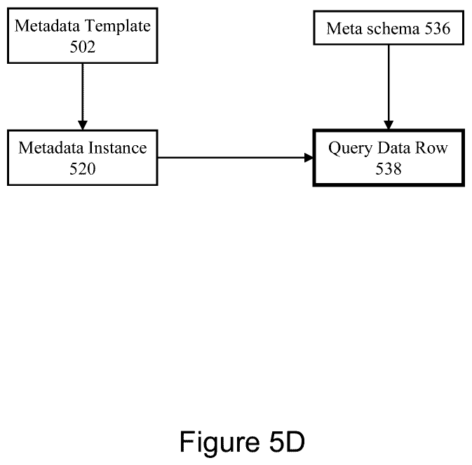

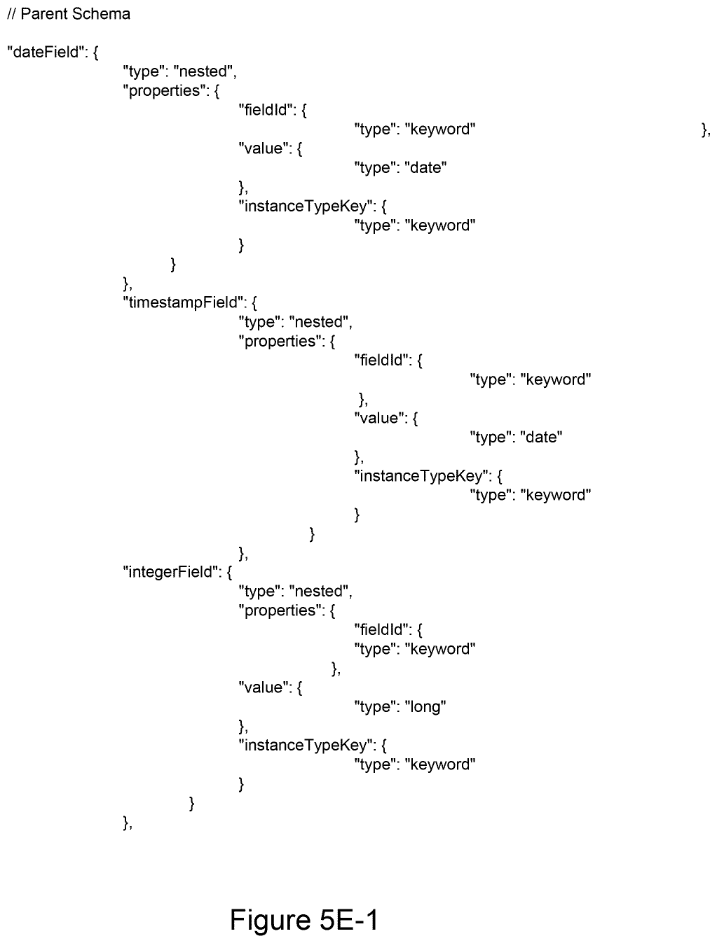

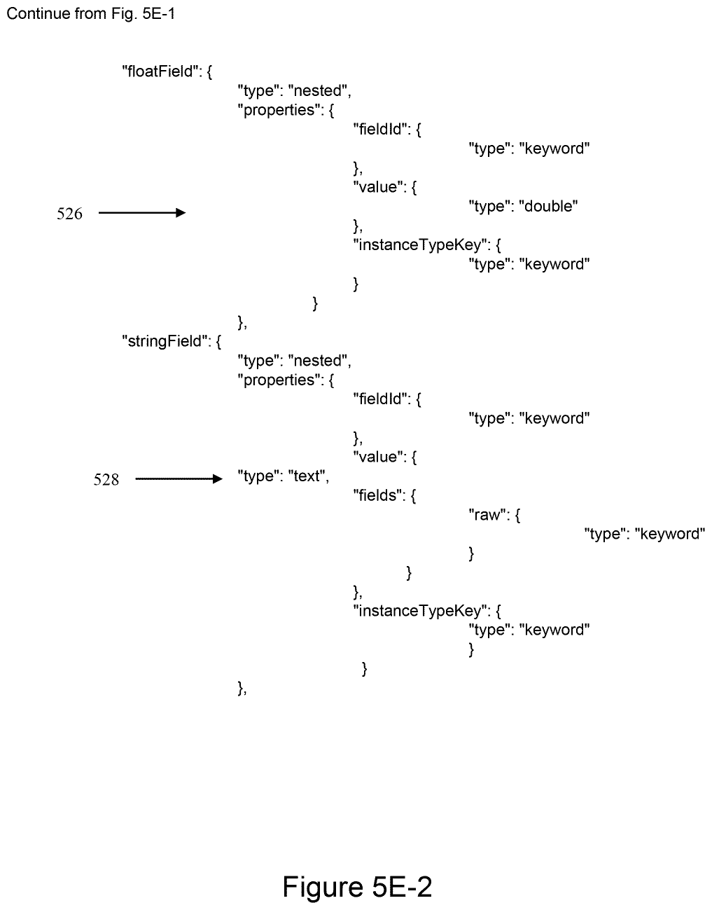

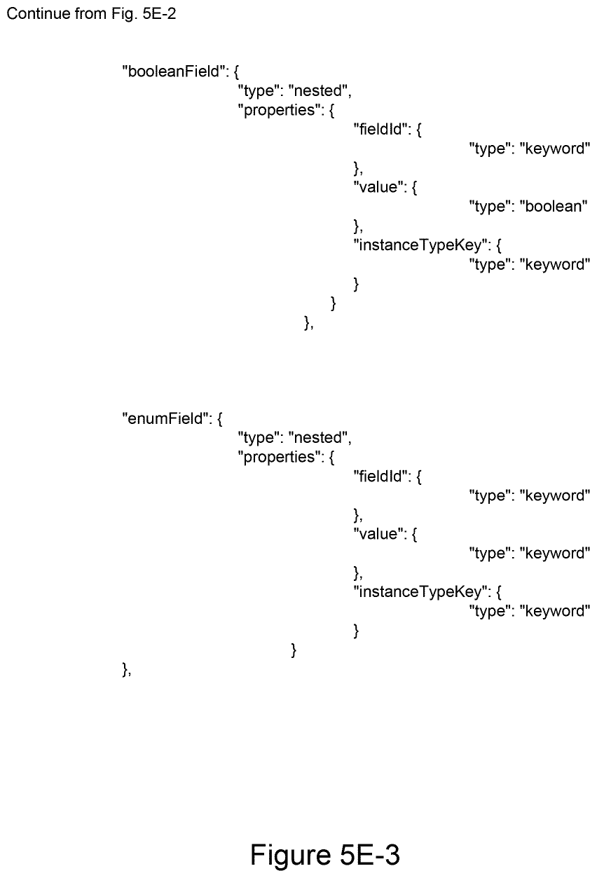

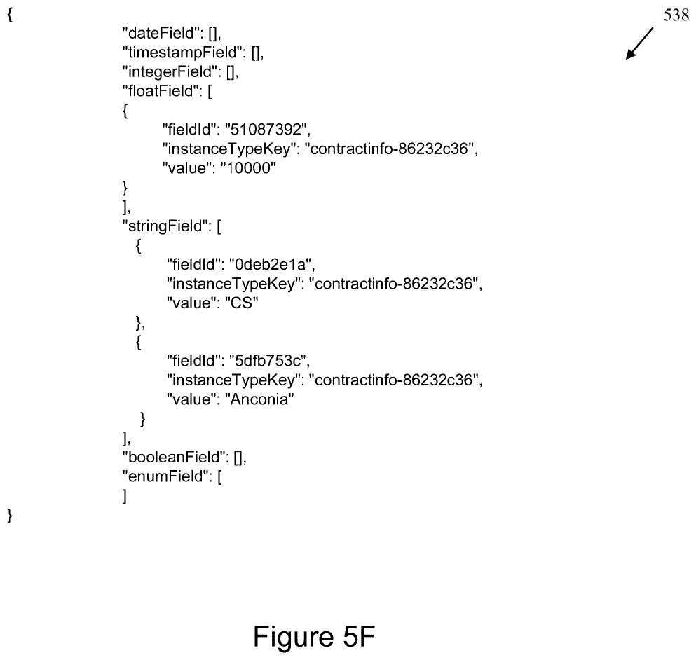

FIGS. 5A-B provide an illustrative example of this process. FIG. 5A shows an example metadata template 502. The metadata template is defined to include one or more fields. In this example, template 502 was likely created for contract-related or invoice-related documents, and hence it includes fields appropriate for such documents. For example, field 504 pertains to metadata for an “amount” field that corresponds to a contract amount, along with parameters associated with this type of field such as a defined type of “float” for these metadata values and identifying its key as “amount”. Field 506 pertains to metadata for a “vendor name”, which is defined to be a type “string”, and having a key “vendorname”. Field 508 pertains to metadata for a “department”, which is defined to be a type “string”, and having a key “department”.

As previously noted, one or more objects may be created according to the metadata template 502. FIG. 5B shows an example user interface 510 for creating/viewing an object created according to a metadata template. Here, portion 512 shows an example document that has been created according to the temple, which is an invoice that has been generated with certain filed values inside the document. Portion 514 of the interface 510 shows the metadata associated with this document. FIG. 5C shows an example metadata instance 520 that may be created for the document shown in FIG. 5B. This metadata instance 520 is populated with the metadata values that were included in the document shown in the previous figure.

The metadata values are extracted for the document and stored within a metadata store. As shown in FIG. 5D, the metadata template 502 is used in conjunction with the metadata instance 520 to correspond to an associated query data row 538 in the query store. The meta schema 536 is also employed to help generate a query data row 538 that is placed into a query store. It is this set of metadata that is maintained for a specific instance, and which is searched upon wen processing user queries.

FIGS. 5E-1, 5E-2, and 5E-3 show an example of a meta schema. It is noted that this meta schema includes portions that correspond to each of the fields that exist within the metadata template 502, and well as the fields within other metadata templates within the system. For example, portion 526 in the meta schema defines a “floatfield” type, which would be associated with the “contract amount” field 504 in template 502. Portion 528 in the meta schema defines a “stringfield” type which would be associated with the “vendor name” field 506 and “department” field 508 in the template 502.

FIG. 5F shows an example of a query data row 538 that is produced by the combination of the metadata instance 520 and the meta schema 536. This query data row 538 includes the appropriate data that will be used in the later query processing actions to identify the specific instance that is associated with this query data row. As will be described later, any incoming user metadata query will be transformed into various intermediate query formats based upon the query predicates and the meta schema, which will be applied to attempt to match the information placed into this query data row 538.

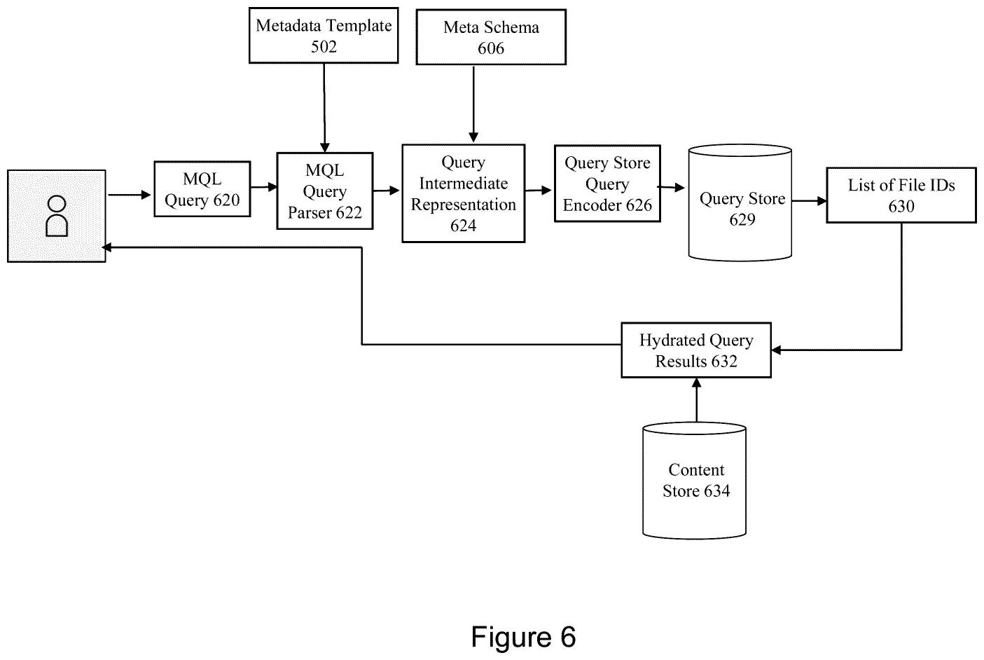

FIGS. 6, 7, and 8 provide an illustration of an approach to process a metadata query according to some embodiments of the invention. A user may issue a metadata query 620 to query against the metadata for objects in the system. For example, a user may issue the query in the MQL format. The syntax and format of a MQL query is similar to that of a SQL database. For example, the following is an example metadata query for all files and folders that match a contract metadata template with a contract value of over $100 the following metadata query could be created:

```
{
  “from”: “foo_enterprise.contracttemplate”,
  “query”: “amount >= :value”;
  “query_params”: {
    “value”: 100
  },
  “fields”:{
    “name”,
    “metadata.foo_enterprise.contracttemplate.amount”
    },
}
```

The “from” value represents the scope and templateKey of the metadata template, and the ancestor_folder_id represents the folder ID to search within, including its subfolders. This query is presented against a specific template (“foo_enterprise.contracttemplate”), and seeks to query for contract(s) according to this template having a metadata for “amount” that is greater than or equal to “100”.

Normally, the metadata query will only return the base-representation of a file or folder, which includes their id, type, and etag values. To request any additional data the fields parameter can be used to query any additional fields, as well as any metadata associated to the item. For example: (a) created_by will add the details of the user who created the item to the response; (b) metadata.<scope>.<templateKey> will return the base-representation of the metadata instance identified by the scope and templateKey; and (c) metadata.<scope>.<templateKey>.<field> will return all fields in the base-representation of the metadata instance identified by the scope and templateKey plus the field specified by the field name. Multiple fields for the same scope and templateKey can be defined. The query parameter represents the SQL-like query to perform on the selected metadata instance. This parameter is optional, and without this parameter the query would return all files and folders for this template. Every left hand field name, like amount, needs to match the key of a field on the associated metadata template. In other words, you can only search for fields that are actually present on the associated metadata instance. Any other field name will result in the error returning an error. To make it less complicated to embed dynamic values into the query string, an argument can be defined using a colon syntax, like: value. Each argument that is specified like this needs a subsequent value with that key in the query_params object. The metadata query may also support any number of logical operators, such as AND, OR, NOT, LIKE, etc. Various comparison operators may also be supported, such as =, >, <, >=, <=, etc. Pattern matching may be implemented using these operators, e.g., to match a string to a pattern or a number type to a numeric value.

The MQL query will be received and parsed by an MQL parser 622. The MQL parser 622 is responsible for analyzing and interpreting the keywords and parameters that are included within the MQL parser. The predicates within the MQL predicate will be identified using the parser 622. For example, assume that predicates 702 correspond to the predicates that were identified by a parser for an MQL query that was received for the metadata template 502 discussed above.

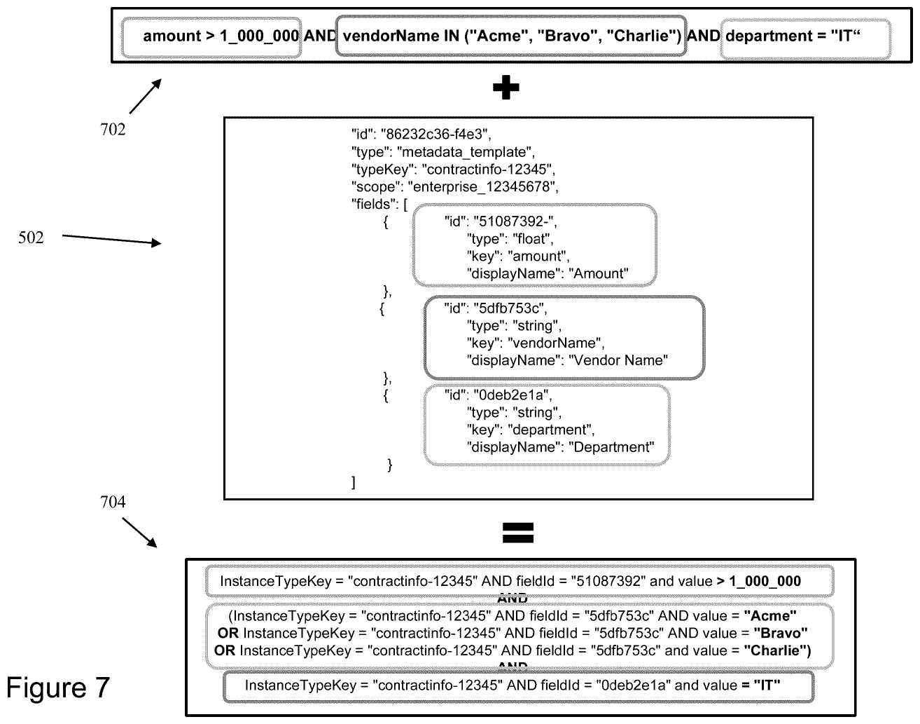

An intermediate query representation will be generated from the parsed MQL query. In particular, as shown in FIG. 7, the query predicates 702 will be analyzed in combination with the metadata template 502 to form an intermediate query representation 704. The intermediate query representation 704 corresponds to a parsed tree representation based upon the specific template 502 being queries. Here, it can be seen that the intermediate query representation 704 includes, for example, information about the typekeys and field IDs for the specific predicates identified from the query.

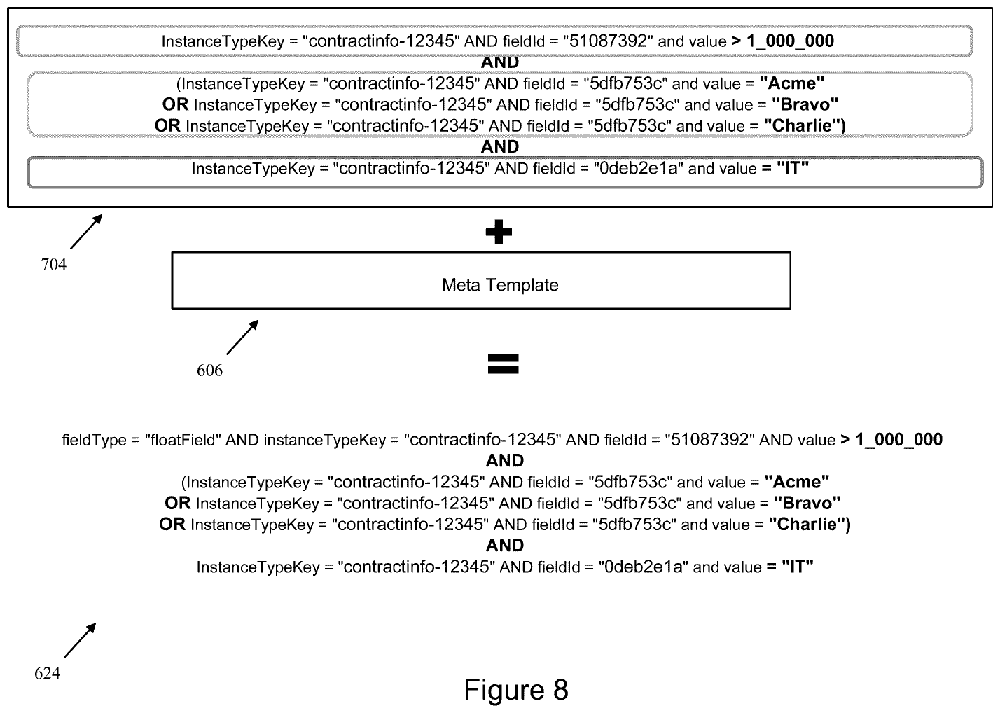

As illustrated in FIG. 8, the intermediate query representation 704 is then analyzed in combination with the meta schema 606 to form another intermediate representation 624. This intermediate representation 624 will now include additional information that is obtained from reviewing the meta schema. For example, routing information is included in the intermediate representation 624 from the meta schema. As shown in the figures, the additional information included in the intermediate representation 624 may correspond to, for example, fieldtype and instancetypekey information.

Next, as shown in FIG. 6, the intermediate representation 624 may be sent to a query store query encoder 626 to generate a query in a format that is suitable to be executed against the query store. This action is highly dependent upon the specific type of query store and query processor that is selected at this stage. For example, assume that an implementation of the invention uses elastic search to process the metadata query. In this example scenario, the query store query encoder 626 would generate a final query in the EQL query syntax from the intermediate query representation 624, and an elastic search would be performed against the query store 628. However, it is noted that this approach of using elastic search is merely illustrative, and the invention is not limited to only this type of search.

The execution of the metadata query will then generate a set of results that identify the files or folders that match the query terms. In some embodiments, the query will produce a set of file or folder IDs from the search of the query store. However, since the actual files/folders themselves are stored in another location in the content store 634, this means that a hydration step 632 is employed to hydrate the results such that the files/folders are provided to the user.

Therefore, what has been described is an improved approach to implement metadata queries, e.g., for content stored in a cloud-based content management system. With embodiments of the invention, instead of being required to create and maintain a separate schema for each document type stored within the system, a single meta schema can be employed to facilitate processing for the metadata query. The meta schema is used to generate a query schema for processing of a query against metadata.

### System Architecture Overview

### Additional System Architecture Examples

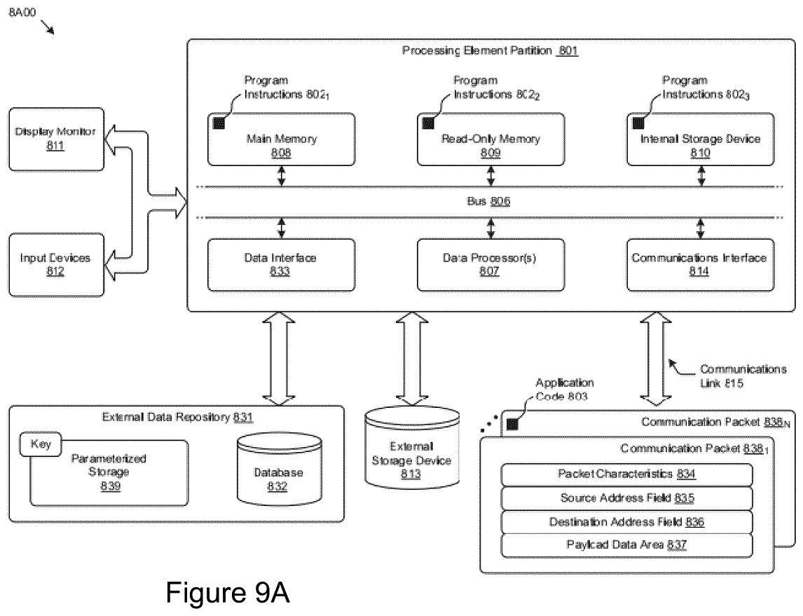

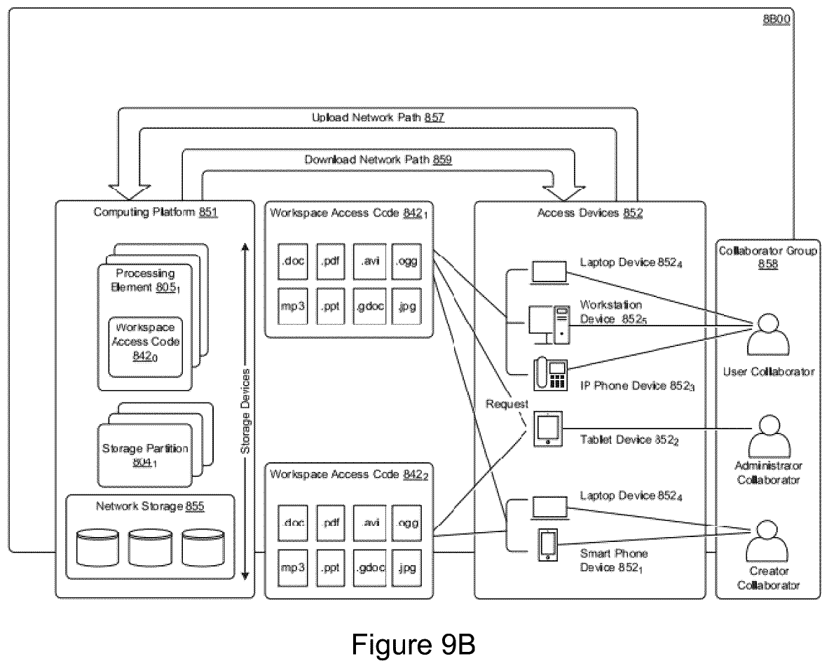

FIG. 9A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 8021, program instructions 8022, program instructions 8023, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 8381, communication packet 838N) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to form and template detection. A module may include one or more state machines and/or combinational logic used to implement or facilitate the operational and/or performance characteristics pertaining to form and template detection.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of form and template detection). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to form and template detection, and/or for improving the way data is manipulated when performing computerized operations pertaining to analyzing the features of incoming content objects to match to machine-learned features that define a document template.

FIG. 9B depicts a block diagram of an instance of a cloud-based environment 8B00. Such a cloud-based environment supports access to workspaces through the execution of workspace access code (e.g., workspace access code 8420, workspace access code 8421, and workspace access code 8422). Workspace access code can be executed on any of access devices 852 (e.g., laptop device 8524, workstation device 8525, IP phone device 8523, tablet device 8522, smart phone device 8521, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 8051). The workspace access code can interface with storage devices such as networked storage 855. Storage of workspaces and/or any constituent files or objects, and/or any other code or scripts or data can be stored in any one or more storage partitions (e.g., storage partition 8041). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
generating a plurality of templates for content managed by a content management system, wherein each template of the plurality of templates comprises fields for entry of designated information within a document;
correlating the plurality of templates to a common meta schema instead of maintaining a separate schema for each separate template;
receiving a query for processing against the document; and
performing query processing by generating a query schema from the meta schema, wherein the query schema corresponds to a template for the document.

2. The method of claim 1, further comprising:
creating the document;
populating metadata for the document;
creating a metadata instance for the document; and
creating an index object in a query store for the document.

3. The method of claim 1, further comprising:
fetching the template that corresponds to the document;
transforming the query using the meta schema; and
executing a transformed query against a query store.

4. The method of claim 3, wherein the query is transformed from a query language format into a format corresponding to a field of the template for the document.

5. The method of claim 4, wherein an identification is made of the fields in the meta schema that correlate to the query, and populating the transformed query with identified fields from the meta schema.

6. The method of claim 1, wherein the query processing produces a set of document identifiers, and a hydrated result set if produced by retrieving documents corresponding to the document identifiers.

7. A computer program product embodied on a non-transitory computer readable medium, the computer readable medium having stored thereon a sequence of instructions which, when executed by a processor, executes a method comprising:
generating a plurality of templates for content managed by a content management system, wherein each template of the plurality of templates comprises fields for entry of designated information within a document;
correlating the plurality of templates to a common meta schema instead of maintaining a separate schema for each separate template;
receiving a query for processing against the document; and
performing query processing by generating a query schema from the meta schema, wherein the query schema corresponds to a template for the document.

8. The computer program product of claim 7, further comprising:
creating the document;
populating metadata for the document;
creating a metadata instance for the document; and
creating an index object in a query store for the document.

9. The computer program product of claim 7, further comprising:
fetching the template that corresponds to the document;
transforming the query using the meta schema; and
executing a transformed query against a query store.

10. The computer program product of claim 9, wherein the query is transformed from a query language format into a format corresponding to a field of the template for the document.

11. The computer program product of claim 10, wherein an identification is made of the fields in the meta schema that correlate to the query, and populating the transformed query with identified fields from the meta schema.

12. The computer program product of claim 9, wherein the query processing produces a set of document identifiers, and a hydrated result set if produced by retrieving documents corresponding to the document identifiers.

13. A system, comprising:
a processor;
a memory for holding programmable code; and
wherein the programmable code includes instructions executable by the processor for: generating a plurality of templates for content managed by a content management system, wherein each template of the plurality of templates comprises fields for entry of designated information within a document; correlating the plurality of templates to a common meta schema instead of maintaining a separate schema for each separate template; receiving a query for processing against the document; and performing query processing by generating a query schema from the meta schema, wherein the query schema corresponds to a template for the document.

14. The system of claim 13, further comprising:
creating the document;
populating metadata for the document;
creating a metadata instance for the document; and
creating an index object in a query store for the document.

15. The system of claim 13, further comprising:
fetching the template that corresponds to the document;
transforming the query using the meta schema; and
executing a transformed query against a query store.

16. The system of claim 15, wherein the query is transformed from a query language format into a format corresponding to a field of the template for the document.

17. The system of claim 16, wherein an identification is made of the fields in the meta schema that correlate to the query, and populating the transformed query with identified fields from the meta schema.

18. The system of claim 13, wherein the query processing produces a set of document identifiers, and a hydrated result set if produced by retrieving documents corresponding to the document identifiers.
